(19) United States
(12) Patent Application Publication
(10) Pub. No.: US 2019/0009504 A1
(43) Pub. Date: Jan. 10, 2019

(54) PLASTIC FILM

(71) Applicant: Dongguan Sengtor Plastic Products Co., Ltd., Dongguan (CN)

(72) Inventor: Xuefen Ren, Dongguan (CN)

(21) Appl. No.: 15/798,437

(22) Filed: Oct. 31, 2017

Related U.S. Application Data
(63) Continuation of application No. PCT/CN2017/092382, filed on Jul. 10, 2017.

(51) Int. Cl. B32B 27/08; B32B 27/32; B32B 27/20

(52) U.S. Cl. CPC B32B 27/08; B32B 27/32; B32B 2553/00; B32B 2323/10; B32B 27/20

(57) ABSTRACT

A plastic film includes an outer layer, a middle layer, and an inner layer. Each of the outer, middle, and inner layers includes a polyolefin elastomer. The polyolefin elastomer has better fluidity and can improve the dispersion effect of the polypropylene base raw material. The polypropylene base raw materials are mixed evenly and enhance the connection strength of the outer, middle, and inner layers of the plastic film. Each of the outer, middle, and inner layers includes a polyphthalamide resin, which can make the component more compact, more effective to enhance the tensile force. The plastic film has strong pulling force and is not easily damaged.

### CROSS REFERENCE TO RELATED APPLICATIONS

The present application is a Continuation Application of PCT Application No. PCT/CN2017/092382 filed on Jul. 10, 2017. All the above are hereby incorporated by reference.

### FIELD

The subject matter herein generally relates to plastic films.

### BACKGROUND

A plastic film is a film made of polyvinyl chloride, polyethylene, polystyrene and other resins. The plastic film is used for packaging and as a coating.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

The present disclosure is described in relation to a plastic film.

One exemplary embodiment of a plastic film is illustrated as follows.

The plastic film comprises an outer layer, a middle layer, and an inner layer.

The outer layer comprises a first polypropylene base material, a polyolefin elastomer, and a polyphthalamide resin. The first polypropylene base material comprises a random copolymer polypropylene and a low melt copolymer polypropylene. In at least one exemplary embodiment, in each outer layer material, a weight percentage range of the random copolymer polypropylene is substantially 60-70 percent, a weight percentage range of the low melt copolymer polypropylene is substantially 10-20 percent, a weight percentage range of the polyolefin elastomer is substantially 10-20 percent, and a weight percentage range of the polyphthalamide resin is substantially 0.2-1.0 percent. Preferably, in each outer layer material, a weight of the random copolymer polypropylene is 65 kilogramms (kg), a weight percentage of the random copolymer polypropylene is substantially 65 percent, a weight of the low melt copolymer polypropylene is 17.2 kg, a weight percentage of the low melt copolymer polypropylene is substantially 17.2 percent, a weight of the polyolefin elastomer is 17.2 kg, a weight percentage of the polyolefin elastomer is substantially 17.2 percent, a weight of the polyphthalamide resin is 0.6 kg, and a weight percentage of the polyphthalamide resin is substantially 0.6 percent.

The middle layer comprises a second polypropylene base material, a polyolefin elastomer, and a polyphthalamide resin. The second polypropylene base material comprises a random copolymer polypropylene and a homopolymer polypropylene. In at least one exemplary embodiment, in each middle layer material, a weight percentage range of the random copolymer polypropylene is substantially 56-66 percent, a weight percentage range of the homopolymer polypropylene is substantially 26-36 percent, a weight percentage range of the polyolefin elastomer is substantially 2-10 percent, and a weight percentage range of the polyphthalamide resin is substantially 0.2-1.2 percent. Preferably, in each middle layer material, a weight of the random copolymer polypropylene is 61 kg, a weight percentage of the random copolymer polypropylene is substantially 61 percent, a weight of the homopolymer polypropylene is 32 kg, a weight percentage of the homopolymer polypropylene is substantially 32 percent, a weight of the polyolefin elastomer is 6.4 kg, a weight percentage of the polyolefin elastomer is substantially 6.4 percent, a weight of the polyphthalamide resin is 0.6 kg, and a weight percentage of the polyphthalamide resin is substantially 0.6 percent.

The inner layer comprises a third polypropylene base material, a polyolefin elastomer, and a polyphthalamide resin. The third polypropylene base material comprises a syndiotactic copolymer polypropylene and a homopolymer polypropylene. In at least one exemplary embodiment, in each inner layer material, a weight percentage range of the syndiotactic copolymer polypropylene is substantially 56-66 percent, a weight percentage range of the homopolymer polypropylene is substantially 26-36 percent, a weight percentage range of the polyolefin elastomer is substantially 2-10 percent, and a weight percentage range of the polyphthalamide resin is substantially 0.2-1.2 percent. Preferably, in each inner layer material, a weight of the syndiotactic copolymer polypropylene is 61 kg, a weight percentage of the syndiotactic copolymer polypropylene is substantially 61 percent, a weight of the homopolymer polypropylene is 32 kg, a weight percentage of the homopolymer polypropylene is substantially 32 percent, a weight of the polyolefin elastomer is 6.4 kg, a weight percentage of the polyolefin elastomer is substantially 6.4 percent, a weight of the polyphthalamide resin is 0.6 kg, and a weight percentage of the polyphthalamide resin is substantially 0.6 percent.

The polyolefin elastomer on each of the outer, middle, and inner layers of the plastic film is a metallocene polyolefin elastomer, which have better fluidity and can improve the dispersion effect of the polypropylene base materials and the bonding strength between the plastic film layers.

The polyphthalamide resin on each of the outer, middle, and inner layers of the plastic film is a semi-crystalline polyphthalamide resin. The semi-crystalline polyphthalamide resin can make components more compact and more effective to enhance tensile force.

Each of the outer, middle, and inner layers of the plastic film comprises a pigment. The pigment is used to color the plastic film. At least one exemplary embodiment, the pigment of the outer layer of the plastic film is a colored pigment, a weight of the pigment of the outer layer is 9.3 kg; the pigment of the middle layer of the plastic film is a white pigment, a weight of the pigment of the middle layer is 10.6 kg; the pigment of the inner layer of the plastic film is black pigment, a weight of the pigment of the inner layer is 6.5 kg. Each of the outer, middle, and inner layers of the plastic film are different colors to be distinguished each other.

The exemplary embodiments shown and described above are only examples. Many details are often found in the art such as the other features of a plastic film. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A plastic film comprising:
an outer layer comprising:
a first polypropylene base material;
a polyolefin elastomer; and
a polyphthalamide resin;
a middle layer comprising:
a second polypropylene base material;
a polyolefin elastomer; and
a polyphthalamide resin; and
an inner layer comprising:
a third polypropylene base material;
a polyolefin elastomer; and
a polyphthalamide resin.

2. The plastic film of claim 1, wherein the first polypropylene base material comprises a random copolymer polypropylene and a low melt copolymer polypropylene.

3. The plastic film of claim 2, wherein in each outer layer material, a weight percentage range of the random copolymer polypropylene is substantially 60-70 percent, a weight percentage range of the low melt copolymer polypropylene is substantially 10-20 percent, a weight percentage range of the polyolefin elastomer is substantially 10-20 percent, and a weight percentage range of the polyphthalamide resin is substantially 0.2-1.0 percent.

4. The plastic film of claim 3, wherein in each outer layer material, a weight of the random copolymer polypropylene is 65 kilogramms (kg), a weight percentage of the random copolymer polypropylene is substantially 65 percent, a weight of the low melt copolymer polypropylene is 17.2 kg, a weight percentage of the low melt copolymer polypropylene is substantially 17.2 percent, a weight of the polyolefin elastomer is 17.2 kg, a weight percentage of the polyolefin elastomer is substantially 17.2 percent, a weight of the polyphthalamide resin is 0.6 kg, and a weight percentage of the polyphthalamide resin is substantially 0.6 percent.

5. The plastic film of claim 2, wherein the polyolefin elastomer on each of the outer, middle, and inner layers of the plastic film is a metallocene polyolefin elastomer.

6. The plastic film of claim 2, wherein the polyphthalamide resin on each of the outer, middle, and inner layers of the plastic film is a semi-crystalline polyphthalamide resin.

7. The plastic film of claim 2, wherein each of the outer, middle, and inner layers of the plastic film comprises a pigment.

8. The plastic film of claim 1, wherein the second polypropylene base material comprises a random copolymer polypropylene and a homopolymer polypropylene.

9. The plastic film of claim 8, wherein in each middle layer material, a weight percentage range of the random copolymer polypropylene is substantially 56-66 percent, a weight percentage range of the homopolymer polypropylene is substantially 26-36 percent, a weight percentage range of the polyolefin elastomer is substantially 2-10 percent, and a weight percentage range of the polyphthalamide resin is substantially 0.2-1.2 percent.

10. The plastic film of claim 9, wherein in each middle layer material, a weight of the random copolymer polypropylene is 61 kg, a weight percentage of the random copolymer polypropylene is substantially 61 percent, a weight of the homopolymer polypropylene is 32 kg, a weight percentage of the homopolymer polypropylene is substantially 32 percent, a weight of the polyolefin elastomer is 6.4 kg, a weight percentage of the polyolefin elastomer is substantially 6.4 percent, a weight of the polyphthalamide resin is 0.6 kg, and a weight percentage of the polyphthalamide resin is substantially 0.6 percent.

11. The plastic film of claim 9, wherein the polyolefin elastomer on each of the outer, middle, and inner layers of the plastic film is a metallocene polyolefin elastomer.

12. The plastic film of claim 9, wherein the polyphthalamide resin on each of the outer, middle, and inner layers of the plastic film is a semi-crystalline polyphthalamide resin.

13. The plastic film of claim 9, wherein each of the outer, middle, and inner layers of the plastic film comprises a pigment.

14. The plastic film of claim 1, wherein the third polypropylene base material comprises a syndiotactic copolymer polypropylene and a homopolymer polypropylene.

15. The plastic film of claim 14, wherein in each inner layer material, a weight percentage range of the syndiotactic copolymer polypropylene is substantially 56-66 percent, a weight percentage range of the homopolymer polypropylene is substantially 26-36 percent, a weight percentage range of the polyolefin elastomer is substantially 2-10 percent, and a weight percentage range of the polyphthalamide resin is substantially 0.2-1.2 percent.

16. The plastic film of claim 15, wherein in each inner layer material, a weight of the syndiotactic copolymer polypropylene is 61 kg, a weight percentage of the syndiotactic copolymer polypropylene is substantially 61 percent, a weight of the homopolymer polypropylene is 32 kg, a weight percentage of the homopolymer polypropylene is substantially 32 percent, a weight of the polyolefin elastomer is 6.4 kg, a weight percentage of the polyolefin elastomer is substantially 6.4 percent, a weight of the polyphthalamide resin is 0.6 kg, and a weight percentage of the polyphthalamide resin is substantially 0.6 percent.

17. The plastic film of claim 14, wherein the polyolefin elastomer on each of the outer, middle, and inner layers of the plastic film is a metallocene polyolefin elastomer.

18. The plastic film of claim 14, wherein the polyphthalamide resin on each of the outer, middle, and inner layers of the plastic film is a semi-crystalline polyphthalamide resin.

19. The plastic film of claim 14, wherein each of the outer, middle, and inner layers of the plastic film comprises a pigment.

20. The plastic film of claim 19, wherein the a weight of the pigment of the outer layer is 9.3 kg, a weight of the pigment of the middle layer is 10.6 kg, and a weight of the pigment of the inner layer is 6.5 kg.
